(19) United States
(12) Patent Application Publication
(10) Pub. No.: US 2019/0050560 A1
(43) Pub. Date: Feb. 14, 2019

(54) SYSTEMS AND METHODS FOR AUDITING ISOLATED COMPUTING ENVIRONMENTS

(71) Applicant: MICROSOFT TECHNOLOGY LICENSING, LLC, Redmond, WA (US)

(72) Inventors: Yolando PEREIRA, Bellevue, WA (US); Margarit Simeonov CHENCHEV, Sammamish, WA (US); Giridhar VISWANATHAN, Redmond, WA (US); Constantin Sorin OPREA, Bothell, WA (US); John Andrew STARKS, Seattle, WA (US); Kyle Patrick SABO, Seattle, WA (US); Douglas Evan COOK, Redmond, WA (US); Seth Christopher BEINHART, Lynnwood, WA (US); Charles Glenn JEFFRIES, Sammamish, WA (US); Ankit SRIVASTAVA, Seattle, WA (US); Benjamin M. SCHULTZ, Bellevue, WA (US); Hari R. PULAPAKA, Redmond, WA (US)

(21) Appl. No.: 15/857,585

(22) Filed: Dec. 28, 2017

Related U.S. Application Data
(60) Provisional application No. 62/542,743, filed on Aug. 8, 2017.

(51) Int. Cl. G06F 21/55; G06F 11/30; G06F 11/34; G06F 9/455

(52) U.S. Cl. CPC G06F 21/552; G06F 11/3068; G06F 11/34; G06F 9/45558; G06F 21/57; G06F 2009/45583; G06F 2009/45587; G06F 2009/45591; G06F 2009/45562

(57) ABSTRACT

The techniques described herein enable client APIs to be deployed within isolated computing environments while externally exposing and/or maintaining a log of computing events that the client APIs perform and/or attempt to perform within the isolated computing environments. Generally described, configurations disclosed herein enable audit parameters associated with client application programming interfaces (APIs) to be deployed within an isolated computing environment to generate a log of computing events performed by the client APIs. Ultimately, access to the log of computing events is provided externally to the isolated computing environment without exposing sensitive computing resources (e.g., a host operating system (OS)) to the various client APIs.

### PRIORITY APPLICATION

This application claims the benefit of and priority to U.S. Provisional Application No. 62/542,743, filed Aug. 8, 2017, the entire contents of which are incorporated herein by reference.

### BACKGROUND

Auditing of computing events forms an important pillar of information technology as information obtained through auditing helps businesses in several ways. For example, businesses use auditing to build confidence that an employee and/or device is abiding by company processes and procedures. When processes and procedures are being breached, auditing is an important tool to determine what went wrong, to understand why it went wrong, and to assess the extent of damage caused (e.g. information disclosure, repudiation, spoofing, etc.)—if any. In many enterprise environments, auditing is used in a broad sense to review software tool usage, security procedures, government compliance, forensic analysis and so forth. In the case of government networks, extensive auditing is a requirement for a computing system to gain the authorization to operate on the network.

The proliferation of mechanisms that are being deployed to isolate computing events from sensitive computing resources present unique challenges with respect to auditing. For example, under various circumstances it is desirable to deploy applications within isolated computing environments such as, for example, containers and/or light weight virtual machines (VMs) to protect a host operating system (OS). However, under such circumstances it is concurrently desirable for auditing purposes to externally expose and/or maintain a record of the computing events that these applications perform and/or attempt to perform within the isolated computing environments.

It is with respect to these and other considerations that the disclosure made herein is presented.

### DRAWINGS

The Detailed Description is described with reference to the accompanying figures. In the figures, the left-most digit(s) of a reference number identifies the figure in which the reference number first appears. The same reference numbers in different figures indicates similar or identical items. References made to individual items of a plurality of items can use a reference number with a letter of a sequence of letters to refer to each individual item. Generic references to the items may use the specific reference number without the sequence of letters.

FIG. 1 illustrates an exemplary dataflow scenario of a system that generates logs internally within an isolated computing environment to record computing events corresponding to client application programing interfaces (APIs) that are operating within the isolated computing environment and provides access to the logs externally from the isolated computing environment.

FIG. 2 illustrates an exemplary dataflow scenario of a system that generates logs externally from an isolated computing environment to record computing events corresponding to client APIs that are operating within the isolated computing environment.

FIG. 3 illustrates an exemplary dataflow scenario of a system that reads logs of recorded computing events received from a plurality of isolated computing environments and consolidates the logs based on audit parameters.

FIG. 4 illustrates an exemplary dataflow scenario of a system that includes a cloud monitoring service for forwarding queries to individual isolated computing environments and receiving log data in response to the queries to record logs independent of the isolated computing environment.

FIG. 5 is a flow diagram of an example process for generating a log of computing events performed by a client API within an isolated computing environment and providing access to the log outside of the isolated computing environment.

FIG. 6 shows additional details of an example computer architecture for a computer capable of executing the systems and methods for auditing isolated computing environments described herein.

### DETAILED DESCRIPTION

The following Detailed Description describes techniques for providing an isolated computing environment auditing system that provides benefits over conventional auditing systems by, for example, generating logs of event data corresponding to computing events that occur within isolated computing environments. Generally described, configurations disclosed herein enable audit parameters associated with client application programming interfaces (APIs) to be deployed within an isolated computing environment to generate a log of computing events that are performed by the client APIs while operating within the isolated computing environment. Ultimately, access to the log of computing events is provided externally to the isolated computing environment without exposing sensitive computing resources (e.g., a host operating system (OS)) to the various client APIs.

Although conventional auditing systems and techniques are generally compatible with some early forms of virtualization, such systems and techniques are ill-suited for use with newer forms of virtualization that enable multiple OS instances to share computing resources of a single host OS. For example, in many instances the lifespan of an OS instance is extremely short (e.g., on the order of seconds or even milliseconds) such that collecting and maintaining information for auditing is extremely difficult and conventional auditing systems fail to meet expectations for data integrity and completeness. Furthermore, OS instances (e.g., containers and/or lightweight virtual machines) may be used to protect sensitive computing resources (e.g., a host OS) from malicious computing events (e.g., malware attacks). Accordingly, the techniques described herein enable client APIs to be deployed within isolated computing environments while concurrently exposing and/or maintaining a log of computing events that the client APIs perform and/or attempt to perform within the isolated computing environments.

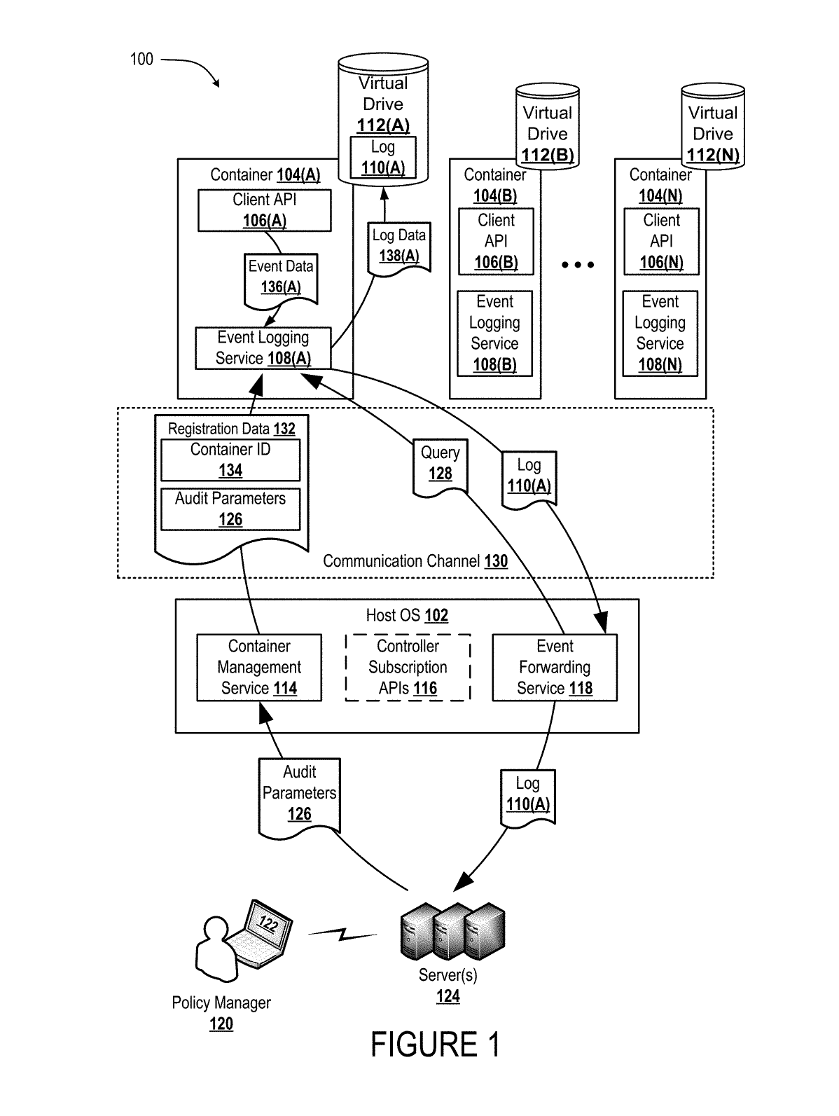

To illustrate aspects of the techniques disclosed herein: FIGS. 1-4 illustrate various data flow scenarios of systems that deploy various components to generate and/or maintain one or more logs for recording computing events that occur within isolated computing environments. Similar to other illustrations described herein, it can be appreciated that operations and/or functionalities may be described according to a logical flow of data between various components. The order in which these operations and/or functionalities are described and/or illustrated herein is not intended to be construed as a limitation. Rather, any number of the operations and/or functionalities described with respect to any one of FIGS. 1-4, may be combined in any order and/or in parallel in accordance with the present disclosure. Other processes and/or operations and/or functionalities described throughout this disclosure shall be interpreted accordingly.

Turning now to FIG. 1, an example dataflow scenario is illustrated with respect to a system 100 that generates logs internally within an isolated computing environment to record computing events corresponding to client APIs that are operating within the isolated computing environment. The system 100 further provides access to the logs externally from the isolated computing environment. As used herein, the term “isolated computing environment” refers generally to any computing mechanism that is configured to isolate computing events from sensitive computing resources. Exemplary isolated computing environments include, but are not limited to, LINUX containers, MICROSOFT HYPER-V containers, WINDOWS SERVER containers, and/or any other operating-system-level virtualization method. Furthermore, although the following detailed description discusses the inventive concepts disclosed herein with respect to containers, it can be appreciated that performance of the inventive concepts described herein with other types of isolated computing environments is contemplated and is within the scope of the present disclosure.

As illustrated, the system 100 may include a host OS 102 that supports one or more isolated computing environments such as, for example, containers A through N that are labeled 104(A) through 104(N), respectively. In various embodiments, the containers 104 are deployed by the system 100 to isolate one or more client APIs 106 from the host OS 102. As a more specific but nonlimiting example, a particular client API 106 may be a web-browser application that is run within a particular container 104 to isolate the host OS 102 from any potential malware that is accessed either intentionally or inadvertently by the web-browser application. As another more specific but nonlimiting example, a client API may be a “productivity platform” that is a local and/or web-based software that is dedicated to producing, modifying, and/or accessing information such as, for example, email, live chat sessions, word processing documents, presentations, workbooks (a.k.a. “worksheets”), and/or Internet/Intranet share sites. Exemplary productivity platforms include, but are not limited to, communication platforms (e.g. email services, instant messaging services, on-line video chat services, etc.) and file hosting platforms (e.g. personal cloud based storage, online file sharing services). Furthermore, in some implementations, the individual productivity platforms may be components of a productivity suite (e.g. GOOGLE G-SUITE, ZOHO Office Suite, or MICROSOFT OFFICE 365). Ultimately, when a particular client API session (e.g., a web-browsing session and/or word processing session) is complete (or at some other time interval for that matter), a corresponding container may be “cleaned up,” deleted, and/or re-created for a subsequent client API session.

In some embodiments, the host OS 102 may be communicatively coupled to an enterprise domain to provide access to enterprise resources. For example, the host OS 102 may provide access to an Intranet service of a specific enterprise wherein the Intranet service provides enterprise employees with access to sensitive and/or proprietary enterprise resources. In some embodiments, the individual containers 104 may be configured to restrict client APIs 106 operating within the individual containers 104 from accessing the enterprise resources. For example, an individual client API 106 may operate within an individual container 104 and may be configured to communicate with an Internet Service Provider (ISP) to access an Internet service (e.g., the World Wide Web) but may be restricted from accessing the Intranet service of the specific enterprise. In some implementations, an individual client API 106 that is operating within an individual container 104 may be enabled to access only a predefined set of resources. For example, in a scenario in which the individual client API 106 is a web browser API, the web browser API may be permitted to access only a predefined set of websites (e.g., based on a whitelist). Additionally or alternatively, the individual client API 106 may be enabled to access all resources except for a predefined set of resources (e.g., based on a blacklist). In various implementations, the host OS 102 is communicatively coupled with an enterprise domain whereas an individual container 104 is not communicatively coupled with the enterprise domain.

In some implementations, individual instances of an event logging service 108 may operate within individual instances of the container(s) 104 to generate and/or maintain a log of computing events performed by one or more client APIs 106 that are also operating within the container(s) 104. For example, as illustrated, an event logging service 108(A) is shown as operating within a container 108(A) to monitor a client API 106(A) and, ultimately, to generate a log 110(A) of computing events performed by the client API 106(A) within the container 108(A). In some implementations, the event logging service(s) 108 may generate the log(s) 110 by receiving and/or monitoring event data 136 that indicates the computing events performed by the client API(s) 106 within particular container(s) 104 and then outputting log data 138 to a virtual drive 112 that corresponds to the particular container 104. For example, as illustrated in FIG. 1, individual virtual Drive 112(A) corresponds to individual container 104(A), individual virtual Drive 112(B) corresponds to individual container 104(B), and so on. As used herein, the term “virtual drive” generally refers to any virtual storage space that is dedicated to and accessible by one or more individual containers. An exemplary virtual drive may include, but is not limited to, a file that is dedicated to and accessible by an individual container and that is formatted in accordance with the Virtual Hard Disk (VHD) file format (e.g., formatted according to the file name extension “.vhd” developed by CONNECTIX and/or MICROSOFT). Other exemplary virtual drives include, but are not limited to, a file share that is provided by the host OS 102, a cloud shared network drive, or any other suitable virtual storage solution.

In some implementations, the virtual drive(s) 112 may be accessible by the host OS 102 in addition to one or more corresponding containers 104. For example, the host OS 102 and/or one or more components residing thereon may be configured to directly access the log 110(A) from the virtual Drive 112(A). In some implementations, the virtual drive(s) 112 may be inaccessible by the host OS 102. In such implementations, accessing the log 110(A) may include routing a query and/or request through the container 104(A) and, ultimately, receiving a reply from the container 104(A) that includes at least some of the log 110(A) (assuming of course that the query and/or request is granted). Stated alternatively, depending on design configurations, the host OS 102 may collect information associated with the logs 110 directly from the virtual drives 112 whereas in other implementations the information associated with the logs 110 may be dynamically forwarded from individual containers 104. It can be appreciated that implementations in which the host OS 102 may collect information directly from the virtual drives 112 may be beneficial in scenarios where individual containers 104 have ephemeral lifetimes (e.g., container lifetimes that last a very short time such as, for example, one second, one-half second, one-quarter second, or even on the order of milliseconds) and/or in scenarios where the lifetime of any particular container 104 is unpredictable. It can further be appreciated that in such implementations (e.g., in which containers have ephemeral lifespans), it may be beneficial to configure the virtual drives 112 to persist independent of the container(s) 104.

In some implementations, individual containers 104 may be configured to create “crash dump” files and to store these files directly to a corresponding virtual Drive 112 for subsequent analysis. For example, an individual container 104(A) may be configured to respond to one or more system errors by copying its corresponding memory to the virtual Drive 112(A).

The host OS 102 may include one or more of a container management service 114, controller subscription APIs 116, and an event forwarding service 118. In some implementations, a policy manager 120 may use a client computing device 122 to connect to one or more servers 124 and, ultimately, to access the container management service 114 to set audit parameters 126 defining an audit policy (e.g., for a particular enterprise). For example, the policy manager 120 may access the container management service 114 to configure audit parameters 126 for individual containers 104 that indicate one or more types of information to log (e.g., record) in association with the individual containers 104 and/or audit parameters 126 for individual APIs 106 that indicate one or more types of information to log in association with the individual APIs 106. In various implementations, the one or more servers 124 may be physical servers residing at an enterprise location (e.g., the one or more servers 124 may be owned and maintained by an enterprise at their place of business). In other implementations, the one or more servers 124 may be virtual servers provided by a cloud computing service such as, for example, AMAZON WEB SERVICES, MICROSOFT AZURE, and/or any other suitable cloud computing service.

In some embodiments, the container management service 114 is configured to enable the policy manager 120 to define the audit parameters 126 that include first audit parameters that correspond to the host OS 102 that are independent of second audit parameters that correspond to the individual containers 104. For example, the first audit parameters that correspond to the host OS 102 may indicate default audit parameters that the system 100 applies by default to any container that is initiated by the host OS 102. Then, the second audit parameters that correspond to an individual container 104 may override the first audit parameters (e.g., override the default). Exemplary audit parameters include, but are not limited to, a predefined listing of types of computing events to log a record of, a predefined listing of the types of client APIs to log a record of computing events for, the size of a storage allocation on which the logs 110 are stored, and/or any other suitable for auditing.

In various implementations, the controller subscription APIs 116 define a list of computing events to be identified by the event loggin service 108 and, ultimately, added to the log 110. For example, the controller subscription APIs 116 may define a list of computing events based on a predetermined query language such as, for example, an XPath query. In various implementations, one or more of the controller subscription APIs 116 may be generated by the container management service 114 in response to audit parameters 126 that are defined based on user input of the policy manager 120. For example, the policy manager 120 may access the container management service 114 to define audit parameters 126 that indicate types of information to collect and/or report in association with a particular client API 106.

The event forwarding service 118 may be configured as a service that may forward event queries 128 to provide the host OS 102 with at least a portion of the log(s) 110 that correspond to the event queries. For example, the event forwarding service 118 may communicate with one or more of the containers 104 via a communications channel 130. In some embodiments, the communications channel 130 may be a virtual socket channel such as, for example, a HYPERVISOR socket channel.

With respect to the example dataflow scenario of FIG. 1, the container management service 114 is shown to obtain audit parameters 126 from the client computing device 122 via the one or more servers 124. As described above, the audit parameters 126 may correspond to user input received from the policy manager 120 to configure an audit policy associated with an enterprise. For example, the policy manager 120 may define one or more types of events to report in association with one or more individual client APIs 106 and/or types of client APIs 106. As a more specific but nonlimiting example, the policy manager 120 may define audit parameters 126 associated with monitoring a user browsing history and/or malware attacks corresponding to a specific web browser client API.

In some implementations, the container management service 114 may transmit registration data 132 to one or more individual containers 104. Exemplary registration data 132 may include a container ID 134 that serves as a unique identity for a particular container to enable one or more components of the system 100 to distinguish between information received from the particular container and one or more other containers. For example, as illustrated, the container 104(A) receives a unique container ID 134 that uniquely identifies the container 104(A) and distinguishes computing events recorded in the log 110(A) from computing events recorded in association with containers other than container 104(A). Exemplary registration data 132 may further include one or more aspects of the audit parameters 126 to inform the event logging service 108(A) as to which types of computing events to record within the log 110(A). For example, the policy manager 120 may define audit parameters 126 that cause the event logging service 108(A) to monitor computing events associated with a particular web browser client API 106 and to log suspected malware type of computing events but to omit browsing history type computing events from the log 110. In various implementations, the event logging service 108 from the individual containers 104 may perform a handshake with the host OS 102 to determine version compatibility and feature support in addition to providing the host with the unique container ID 134.

In some implementations, the event logging service 108(A) that resides inside the container 104(A) may connect to the event forwarding service 118 that resides on the host OS 102 to register itself. For example, the host OS 102 may assign the container ID 134 to the container 104(A) upon its initiation. Then, the event logging service 108(A) may start up within the container 104(A) and establish a connection with the event forwarding service 118 to provide its container ID 134. In some implementations, configuration of the container 104(A) may be performed at the time the container 104(A) is initiated by setting a registration key such that the configuration of the container 104(A) is static. Thus, it can be appreciated that in embodiments configuration changes for a container only take effect upon restarting the container.

In some implementations, individual client APIs 106 may transmit event data 136 to a corresponding event logging service 108. For example, as illustrated, the client API 106(A) is shown to transmit event data 136(A) to the event logging service 108(A) which then records at least a portion of the event data 136(A) to the log 110(A) as log data 138(A). In various implementations, the event logging service 108(A) is configured to generate the log data 138(A) by transforming the event data 136(A) into a suitable format such as, for example, Extensible Markup Language (XML) documents, WINDOWS XML Event Log (EVTX) documents, WINDOWS Event Log (EVT) documents, handles, bools, and/or any other suitable data type. As described in more detail below, once the event logging services 108 have been initiated within individual containers 104, certain supported container events matching pre-defined subscription queries may cause various forms of data to be funneled back to the host OS 102. In various implementations, individual client APIs 106 may be updated based on the audit parameters 126 to enable the audit administrator 120 to define one or more sets of handles that cause data to be funneled from the container(s) 104 to the host OS 102. In some scenarios in which the container(s) 104 are suspended and/or a requested output cannot safely be transmitted back to the host OS 102, the client API 106 may be configured to return an error to the host OS 102.

In some implementations, an individual virtual drive(s) 112 may be configured to persist subsequent to termination of a corresponding container(s) 104 (e.g., after a corresponding container(s) 104 has ceased to exist). For example, the virtual Drive 112(A) may persist on the one or more servers 124 even after the container 104(A) has crashed, been deleted, has been intentionally shut down (e.g., when a user closes a client API running inside the container 104), or as otherwise ceased to exist. Accordingly, in various implementations a record of computing events that have occurred within any particular container 104 may be accessible by one or more components of the system 100 (e.g., the host OS 102 and/or the event forwarding service 118) while a corresponding client API 106 is operating within the particular container 104 and/or after the particular container 104 has been terminated. Thus, it can be appreciated that the disclosed techniques provide benefits over conventional auditing techniques for at least the reason that the policy manager 120 may access the log 110(A) associated with the container 104(A) for auditing purposes even after the container 104(A) crashes, is deleted, or as otherwise terminated.

In some implementations, the event forwarding service 118 may forward a query 128 (also referred to herein as a “subscription query”) to the event logging service 108(A). The query 128 may be a cached subscription XML which is copied into the container 104(A) (e.g., to trigger a subscription XML data feed). In some implementations, all queries 128 will be propagated from the host OS 102 into the container(s) 104 and all information associated with computing events performed by the client API(s) 106 and collected by the host OS 102 will be obtained from the container(s) 104. In some implementations, the policy manager 120 may be provided with an ability to generate audit parameters 126 that append a container ID 134 to a particular channel name to cause the system 100 to target particular channels within the container(s) 104 independent from and/or separately from channels in the host OS 102. Based on the query 128, the event logging service 108(A) may identify at least a portion of the log 110(A) that is responsive to the query 128 and, ultimately, may transmit that portion of the log 110(A) to the event forwarding service 118 on the host OS 102. In some implementations, the event logging service 108(A) is configured to transmit individual portions of the log 110(A) in real-time and/or substantially real-time whenever a computing event that matches the query 128 has been processed by the event logging service 108(A). Additionally or alternatively, the event logging service 108(A) may be configured to transmit the log 110(A) (and/or individual portions thereof) based on predetermined time intervals (e.g., every X minutes, each time a container is shut down, each time a container crashes, etc.).

In various embodiments, the system 100 may restrict the types of data that may be transmitted out of one or more containers 104 across the communications channel 130 and ultimately to the host OS 102. For example, the system 100 may be configured such that only preapproved datatypes are allowed to be transferred across the communications channel 130 to the host OS 102 such as, for example, XML documents, EVTX documents, EVT documents, handles, bools, and/or any other suitable data type. Accordingly, it can be appreciated that because event data 136 is processed by the event logging service 108 within the container 104, the system 100 provides the ability to collect the logs 110 to determine what happened (or is happening) within a container 104 while maintaining isolation boundaries between the host OS 102 and the container 104 (e.g. by allowing only presumably benign data structures to leave individual containers 104).

In some implementations, the host OS 102 may provide access to the log 110(A) via the one or more servers 124. For example, as illustrated, the policy manager 120 may access the log 110(A) for auditing purposes (e.g., to determine whether one or more employees and/or devices are abiding by company processes and/or procedures). Although the one or more servers 124 are illustrated as supporting a single host OS 102, it can be appreciated that in various scenarios the one or more servers 124 may concurrently support a plurality of different host OSs. Accordingly, in some implementations, the event forwarding service 118 may stamp the log 110(A) with a unique ID that corresponds to the host OS 102. In such implementations, once the log 110(A) is received by the policy manager 120, the log 110(A) contains unique IDs corresponding to both the host OS 102 in addition to each individual container 104 from which individual computing events are logged.

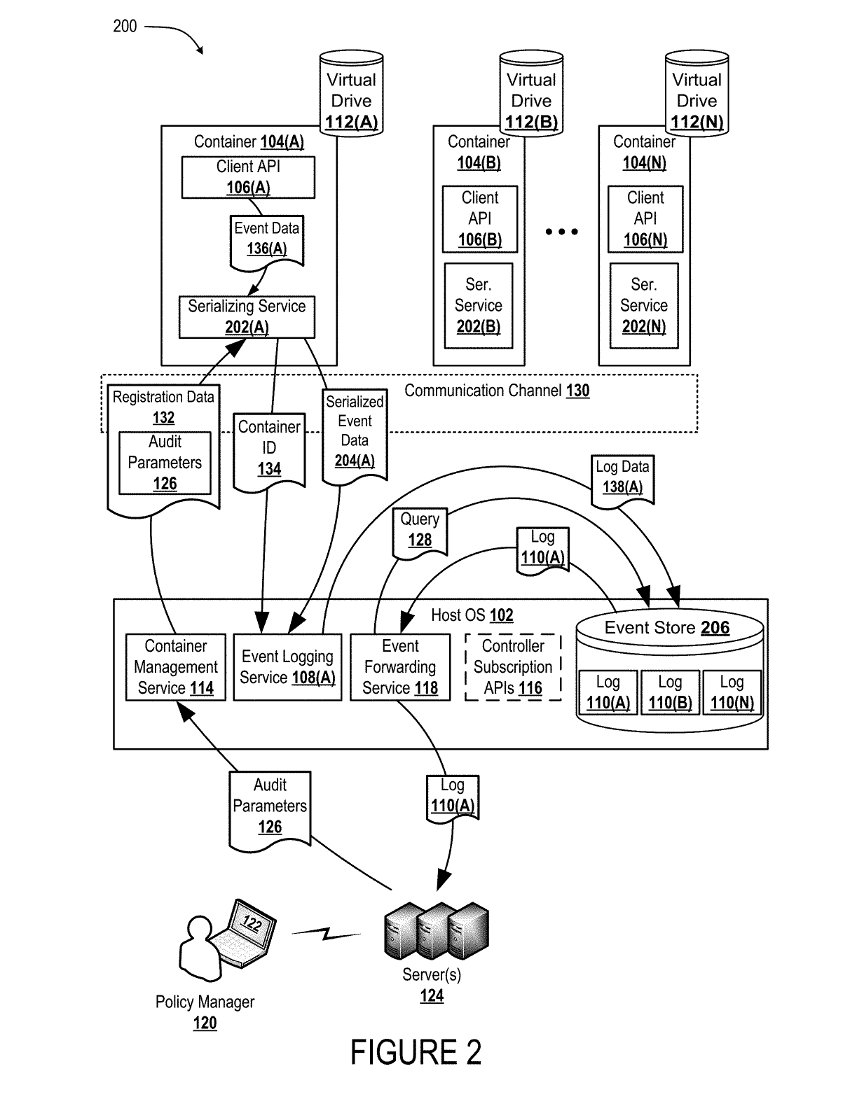

Turning now to FIG. 2, an exemplary dataflow scenario is illustrated of a system 200 that generates logs externally from an isolated computing environment to record computing events corresponding to client APIs 106 that are operating within the isolated computing environment (illustrated as a container 104). It can be appreciated that numerous aspects of this example dataflow scenario are similar to that illustrated with respect to FIG. 1 and, therefore, that numerous aspects of this disclosure introduced with respect to FIG. 1 apply equally to FIG. 2. However, there are difference with respect to the information that is communicated between the container(s) 104 and the host OS 102. In particular, as illustrated, individual container(s) 104 may be configured with a corresponding serializing service(s) 202 that serializes individual computing event records as the event data 136 is received from the client API 106. The serializing service(s) 202 then forward serialized event data 204 through the communications channel 130 to the host OS 102.

In some embodiments, as an individual container 104(A) comes online (e.g., is initiated), a corresponding serialization service 202(A) may establish a communications link with the event logging service 108(A) on the host OS 102 via the communications channel 130. Then, the serialization service 202(A) may perform a handshake with the event logging service 108(A) wherein the handshake includes passing off the container ID 134 to the event logging service 108(A).

After the successful handshake, individual client APIs 106 may transmit event data 136 to a corresponding serializing service 202 which may then serialize a predetermined amount of computing events from the event data 136(A) (e.g., all computing events, a predetermined fraction and/or percentage of the computing events (e.g., every fifth computing event), and/or computing events of a particular type) to generate the serialized event data 204(A). In implementations in which the serializing service 202(A) serializes all computing events associated with the event data 136(A), it can be appreciated that the serializing service 202(A) may operate without performing any processing and/or filtering of the computing events (e.g., the container 104(A) may operate without supporting XPath-based filtering) as performed by the event logging service 108(A).

As further illustrated, the serializing service 202(A) may transmit the serialized event data 204(A) to the event logging service 108(A) which then records at least a portion of the serialized event data 204(A) to an event store 206. Although the event store 206 is illustrated as residing at the host OS 102, the event store 206 may be stored at one or more alternate locations such as for example the one or more servers 124 and/or a cloud storage account.

In some embodiments, as the serialized event data 204(A) is received, the event logging service 108(A) may tag each individual computing event with an indication of which container it originated from. For example, the event logging service 108(A) may modify a metadata field associated with an individual computing event to indicate the container ID 134 within which the individual computing event was performed by a client API 106. Furthermore, the event logging service 108(A) may persist this identifying information throughout the remainder of any processing pipeline associated with the individual computing event. For example, the event logging service 108(A) may persist this identifying information into any log 110 that is configured to store information associated with the individual computing event. As a more specific but nonlimiting example, in a scenario in which the log(s) 110 are formatted as EVTX Files, the event logging service 108(A) may write the identifying information (e.g., the container IDs 134) into one or more of the EVTX files.

Then, similar to as described with relation to FIG. 1, the event forwarding service 118 may forward a query 128 except that, in the implementation illustrated in FIG. 2, the query 128 is passed from the event forwarding service 118 to the event store 206 (rather than the event logging service 108) to identify one or more portions of the log(s) 110 that are responsive to the query 128.

It can be appreciated from the combination of FIGS. 1 and 2 that the event logging service 108 may in various implementations reside on and operate within the host OS 102 and/or individual containers 104. In some embodiments, each of the host OS 102 and individual containers 104 include a corresponding event logging service 108. For example, a first event logging service may reside on the host OS 102 to log computing events performed at the host OS 102 while a second event logging service resides on the individual containers 104 to log computing events performed at the individual containers 104. In such implementations, the second event logging service that resides on the individual containers 104 may indicate a unique container ID 134 that corresponds to individual computing events. In this way, the policy manager 120 is able to distinguish between computing events performed by the individual containers 104 and computing events performed by the host OS 102. In some implementations, each of the host OS 102 and the individual containers 104 store corresponding log 110 of computing events. For example, the host OS 102 may store the log of computing events performed by the host OS 102 whereas the individual containers 104 store logs of computing events performed by the individual containers 104. In some implementations, the policy manager 120 may cause a query 128 to be transmitted directly to the individual containers 104 (e.g., without passing through the host OS 102) to cause the individual containers 104 to return a portion of their corresponding logs 110 that are responsive to the query 128.

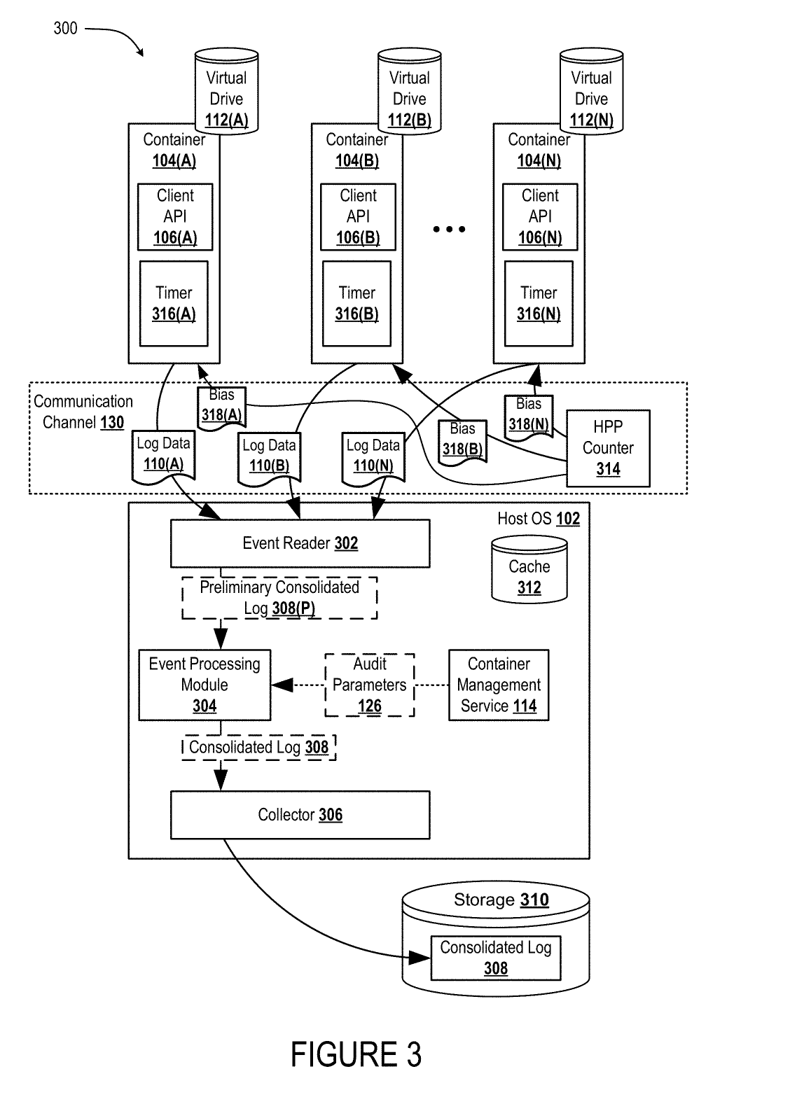

Turning now to FIG. 3, an exemplary dataflow scenario is illustrated of a system 300 that reads logs 110 of recorded computing events received from a plurality of isolated computing environments and consolidates the logs 110 based on audit parameters 126.

In some embodiments, the system 300 comprises a host OS 102 that includes an event reader 302 that receives log data 110 from the plurality of individual containers 104. For example, as illustrated, the event reader receives log data 110(A) from the container 104(A), log data 110(B) from the container 104(B), and so on.

In some embodiments, one or more subscription queries 128 (not shown in FIG. 3) are transmitted from one or more components of the host OS 102 to the plurality of individual containers 104. For example, as discussed in relation to FIG. 1, an event forwarding service 118 may reside on the host OS 102 and may transmit queries 128 to individual ones of the plurality of containers 104. Based on the queries 128, individual containers 104 may transmit back to the host OS 102 corresponding log data 110 (shown in FIG. 3) that indicates one or more computing events performed within the individual containers 104, e.g., by a client API 106.

In some embodiments, the event reader 302 may consolidate the individual events by reading individual events from each of the instances of the log data 110 to measures congruency between the individual events and, ultimately, to generate a consolidated log 308 that includes consolidated records of computing events from the plurality of containers 104. It can be appreciated that both time and event congruency may play an important role in further analysis of the consolidated log 308. Ultimately, the host OS 102 may store the consolidated log 308 for future analysis. As illustrated, the host OS 102 may also transmit the consolidated logs 308 to storage 310 that is external to the host OS 102. For example, the host OS 102 may be directly mapped to a cloud service that host the storage 310. In some implementations, the host OS 102 may store the consolidated log 308 and/or one or more instances of the log data 110 on a local cache 312. For example, the system 300 may be configured to perform only periodic collection and/or analysis of the one or more instances of the log data 110 and/or the consolidated log 308. During times in which the system 300 is not performing collection and analysis of this data it may be stored on the local cache 312.

In some embodiments, the container management service 114 may deploy the audit parameters 126 within an event processing module 304 to prioritize and/or combine events from large numbers of containers 104 (e.g., tens of containers, hundreds of containers, thousands of containers, etc.). It will be appreciated that such embodiments may reduce processing overhead and disk footprint. For example, as illustrated, the event processing module 304 may receive and filter a preliminary consolidated log 308(P) according to the audit parameters 126 to reduce a storage footprint of the consolidated log 308 within event store 206. In various implementations, the event processing module 304 may be configured to filter one or more individual computing events out of the preliminary consolidated log 308(P), merge various aspects of the preliminary consolidated log 308(P), buffer various aspects of the preliminary consolidated log 308(P), and/or throttle known important events from the preliminary consolidated log 308(P).

As illustrated, a collector 306 may be deployed to forward the consolidated log 308 to the storage 310. An exemplary collector may include, but is not limited to, a WINDOWS event collector, and/or any other suitable collector mechanism that that is configured to fulfill subscriptions to receive and store events at a particular storage location (e.g., the storage 310) that are forwarded from an event source (e.g., the host OS 102).

Although the illustrated embodiments show the host OS 102 as including various components (e.g., the event reader 302, the event processing module 304, and/or the collector 306) that are configured to receive, store, process, and/or forward the log data 110, in some implementations the host OS 102 may create a dedicated container for event processing to isolate processing events from the host OS 102. Accordingly, it should be appreciated that any aspects of the present disclosure which are described as taking place within the host OS 102 (or the container(s) 104 for that matter), may in some implementations take place within a dedicated container within which computing events are consolidated and/or combined as part of one or more processing functions. Such implementations may be beneficial to further isolate event processing from the host OS 102 and, therefore, to further reduce various risks associated with such event processing (e.g., a risk of exposure to a malware attack and/or a risk of unauthorized access to sensitive data stored on the host OS 102).

In some embodiments, the system 300 may be configured to synchronize individual computing events of the various instances of log data 110 to enable a deep understanding of the sequence in which the individual computing events have occurred. Exemplary synchronization techniques include, but are not limited to, physical timer techniques, logical timestamps techniques, and/or Global state techniques. It can be appreciated that various synchronization techniques have unique benefits and drawbacks and may provide varying levels of precision in distributed container systems such as system 300. For example, maintaining perfectly synchronized physical clocks in a distributed container system may be a very challenging. In particular, although physical timers provide a stamped time for individual computing events, synchronization physical timers that are distributed across the system requires an accurate measurement of round-trip delay—which unfortunately is not guaranteed especially with network protocols. At least two methods exist for measuring round-trip delay. In a first method, each node (e.g., each container) asks a centralized server for the time according to one or more widespread protocols (e.g., Network Time Protocol (NTP), Precision Time Protocol (PTP) Simple Network Time Protocol (SNTP). In a second method, a centralized time server scans all nodes periodically, calculates an average, and informs each node how it should adjust its time relative to its present time. Other synchronization methods may include WWV, GPS and LORAN. With respect to logical timestamps and clocks, there exist algorithms like the Lamport's timestamp algorithm and the vector clock algorithm. Logical timestamps ensure the correct order of events even in distributed systems but they do not provide the actual time of the events. Some embodiments use a global protocol state machines to logically arrange the messages. Global state is usually used to collect the current state of a distributed system called a distributed snapshot. It consists of all local states and messages in transit.

In some embodiments, the system 300 correlates, sequences, and/or synchronizes individual computing events (e.g., received from the host OS 102 and/or individual containers 104) by providing individual computing events with timestamps using a synchronized timer 316. For example, this may be achieved by synchronizing a high precision performance (HPP) counter 314 (e.g., a QueryPerformanceCounter (QPC)). A partition creation flag may be provided to the communication channel 130 that indicates that any particular partition 104 should have its reference time synchronized to that of the host OS 102. The host OS 102 updates the communication channel 130 (which in some implementations may be a hypervisor) with its bias 318 (e.g., offset and/or scale). The communication channel 130 may then communicate this bias 318 information to the individual containers 104 to cause the individual containers 104 to synchronize their respective timers 316 with that of the host OS 102. In particular, the individual containers 104 use the bias information as host OS correction parameters to adjust their timers 316 appropriately. As illustrated, the HPP counter 314 is shown to transmit bias information 318(A) to the container 104(A) to enable adjustment of the timer 316(A), bias information 318(B) to the container 104(B) to enable adjustment of the timer 316(B), and so on. Ultimately, the individual containers 104 utilize each of their respective timers 316—which are now synchronized with that of the host OS 102—to timestamp individual computing events of the event data 136 generated by the client APIs 106(A) through 106(N). This has a few interesting side effects:
Today on Windows if one wants to measure how long a virtual environment has been up from inside the virtual environment including hypervisor partition creation and firmware boot, they can potentially read the partition reference time. With the above approach, this will not work anymore.
When entering connected standby, the partition reference time is paused. Resume from connected standby resumes the reference time from where it was. Guest clock interrupts are paused and resumed. In this case, these new partitions will not have their reference time frozen, however guest timers will be paused. Thus, on return from connected standby (or resume from pause, or restore) the timers may immediately go off (since they should have fired long in the past) and the guest will observe a large jump in time. This time will be in sync with the host.
When restoring a partition, the saved state contains (and restores) the last known reference time. The restore chunk for this new type of partition will be dropped. It is in theory possible for the saved-state time to be after the current reference time in which case dropping the chunk would be undesirable since it would result in time appearing to go backwards within the virtual environment.
The value of QPC within the host consists of a value provided by a hardware counter, and a QPC bias. The host can communicate the value of this bias to the hypervisor whenever it changes, and the hypervisor will show through this value to the guests created with the new flag. It is up to the guest to apply the bias as needed.
The assumption is that the host will use invariant Time Stamp Counter(TSC) as a source of reference time when available, or the hypervisor reference time when nested. A new set of flags tells the virtual environments that they should synchronize their QPC with the root by using the QPC bias that the hypervisor will expose to them, and selecting either TSC or reference TSC page in the case of nested virtualization as the hardware source.

In some embodiments, the client APIs 106(A) through 106(N) may be communicatively coupled may be configured to communicate with one another during operation such that the consolidated log 308 that includes the serialized computing events can be used to analyze interactions between the client APIs 106(A) through 106(N). For example, in some scenarios, the system 300 may be configured to run each instance of a client API 106 within an individual instance of a container 104. For example, the host OS 102 may support operation of multiple instances of a word processing application (e.g., MICROSOFT WORD) and may run each instance of the word processing application within a different container 104. During operation, the multiple instances of the word processing application may perform various computing events that cause communication between instances (e.g., a user may cut and paste material from a first word processing application instance to a second word processing application instance). Accordingly, it can be appreciated that the techniques disclosed herein provide benefits over conventional auditing techniques for at least the reason that the consolidated log 308 may be analyzed to obtain a rich understanding of interactions between multiple isolated instances of client APIs for auditing purposes.

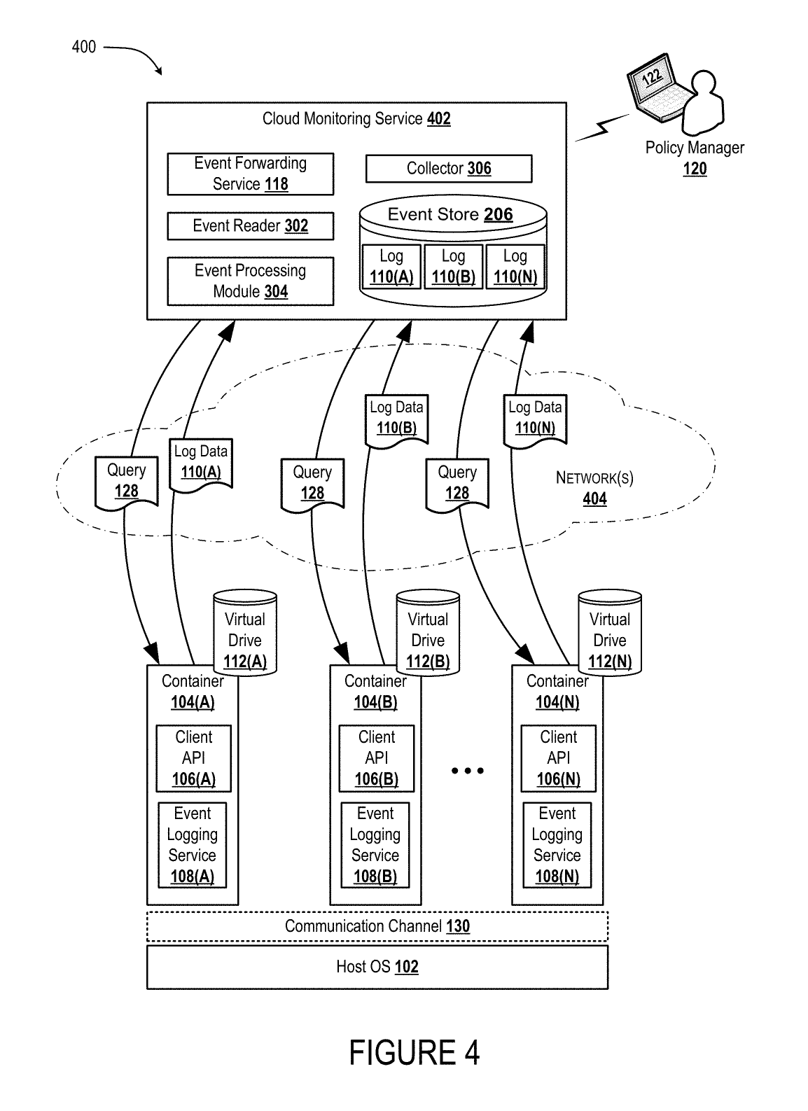

Turning now to FIG. 4, an exemplary dataflow scenario is illustrated of a system 400 that includes a cloud monitoring service 402 for forwarding queries 128 to individual isolated computing environments (illustrated as containers 104) and receiving one or more logs 110 in response to the queries 128. As illustrated, the cloud monitoring service 402 may include one or more of the event forwarding service 118, the event reader 302, the event processing module 304, the collector 306, and/or the event store 206 to store one or more logs 110. In this example, the cloud monitoring service 402 directly communicates with individual containers 104 via one or more networks 404 (e.g., the Internet). As illustrated, the cloud monitoring service 402 may push queries 128 to the individual containers 104. Then, based on the queries 128, event logging services 108 that are operating on the individual containers 104 may access their respective virtual drives 112 and, ultimately, may return log data 110 to the cloud monitoring service 402. The policy manager 120 may then directly log into (e.g., by providing credentials) the cloud monitoring service 402 via a client device 122 to access the logs 110 from the event store 206 for auditing purposes. It can be appreciated that such an implementation provides tangible computing benefits over conventional auditing techniques by substantially isolating computing event logging and/or processing from the host OS 102 for increased security as well as reducing the processing burden on the host OS 102 (e.g., parsing and/or processing of the computing events occurs remotely from the host OS 102).

According to various implementations described herein, the one or more logs 110 may be configured to persist subsequent to the host OS 102 being shut down, refreshed, and/or serviced. For example, as illustrated in FIG. 4, the event store 206 is located on a cloud monitoring service 402 that operates independently of the host OS 102 such that persistence of the event store 206 and or any contents thereof is not dependent on an operational state of the host OS 102. Accordingly, it can be appreciated that in the illustrated implementation any records of computing events that have been performed within the containers 104 that have been successfully recorded in two one or more of the logs 110 will persist even in the event of a container failure and/or a host OS failure.

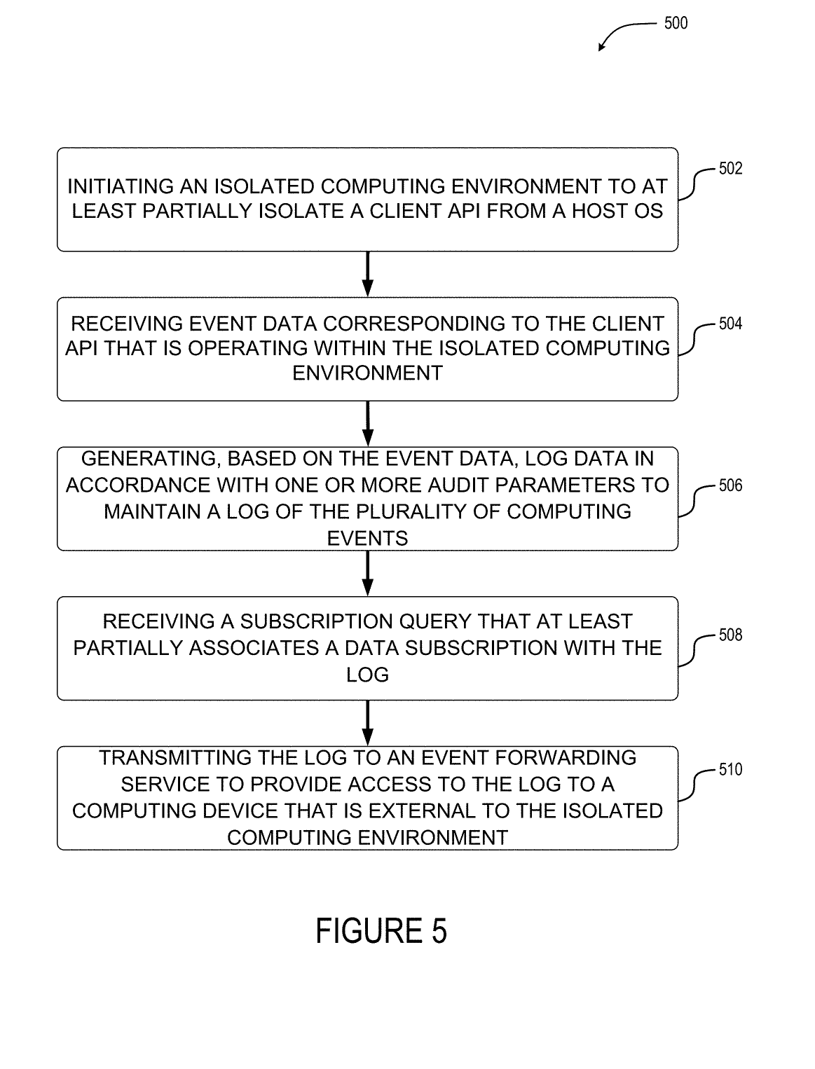

Turning now to FIG. 5, a flow diagram is illustrated of an example process 500 for generating a log of computing events performed by a client application programing interface (API) within an isolated computing environment and providing access to the log outside of the isolated computing environment. The process 500 is described with reference to FIGS. 1-4. The process 500 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform or implement particular functions. The order in which operations are described is not intended to be construed as a limitation, and any number of the described blocks can be combined in any order and/or in parallel to implement the process. Other processes described throughout this disclosure shall be interpreted accordingly.

At block 502, a system may initiate an isolated computing environment such as, for example, a container 104 to at least partially isolate a client API 106 from a host OS 102. Initiating the isolated computing environment may include deploying a container management service 114 to transmit registration data 132 to the isolated computing environment. As shown in FIG. 1, the registration data 132 may include a container ID 134 that is usable to uniquely identify the isolated computing environment and/or to distinguish computing events performed within the isolated computing environment from other computing events performed in other isolated computing environments. As further shown in FIG. 1, the registration data 132 may include audit parameters 126 that indicate types of information to collect and/or report in association with the client API 106.

At block 504, one or more components of the system may receive event data 136 corresponding to the client API that is operating within the isolated computing environment. The event data 136 may indicate a plurality of computing events that have been performed by the client API while operating within the isolated computing environment. As shown in FIG. 1, in some implementations the event data 136 may be received by an event logging service 108 that resides on and operates within the isolated computing environment. Additionally and/or alternatively, as shown in FIG. 2, in some implementations the event data 136 may be received by a serializing service 202 that resides on and operates within the isolated computing environment. In such implementations, the serializing service 202 may minimally transform the event data 136 by for example serializing the event data 136 into serialized event data 204 that is then transmitted across a communications channel 130 to an event logging service 108 that resides on the host OS 102. Additionally and/or alternatively, one or both of the event data 136 and/or the serialized event data 204 may be transmitted from the isolated computing environment to a cloud monitoring service 402 via one or more networks 404 rather than to the host OS 102 over the communications channel 130. For example, as illustrated in FIG. 4, the event logging service 108 may reside on a container 104 and may receive a query 128 from a cloud monitoring service 402 via the one or more networks 404. Then, in response to the query 128, the event logging service 108 may transmit log data 110 directly to a cloud monitoring service 402. Thus, it can be appreciated that in some implementations the log data 110 is neither processed on nor passes through the host OS 102.

At block 506, one or more components of the system may generate log data 138 based on the event data and in accordance with one or more audit parameters 126. Ultimately, the log data 138 may be used to maintain a log 110 of the plurality of computing events that have been performed by the client API 106 while operating within the isolated computing environment. In some implementations, the log 110 may be stored on a virtual drive 112 that specifically corresponds to the isolated computing environment. For example, the isolated computing environment may be a container 104 having a dedicated virtual hard drive (VHD) in the event logging service 108 may operate within the container 104 and may store the log 110 to the VHD. In some implementations, the log may be stored on an event store 206 corresponding to the host OS 102. For example, the event logging service 108 may operate on the host OS 102 (or the isolated computing environment for that matter) and may directly write the log data 138 into a log 110 of the event store 206.

In some implementations, the system may be configured to prevent one or more data types from being transmitted from the isolated computing environment to the host OS 102. As a more specific but nonlimiting example, the system may include a communication channel 130 that is configured to restrict data flows between the host OS 102 and the isolated computing environment with the exception of data files that are formatted specifically as EVT and/or EVTX formatted files.

At block 508, one or more components of the system may receive a subscription query 128 that at least partially associates a data subscription with the log 110. For example, the subscription query 128 may associate a data subscription with the log 110 to cause the event logging service 108 to identify one or more predetermined types of computing event performed by one or more predetermined client APIs and/or types of client APIs. As a more specific but nonlimiting example, a data subscription may cause the event logging service 108 to identify instances of a particular web-browsing client API attempting to access one or more untrusted and/or unapproved websites (e.g., social media sites, dating websites, and/or any other type of website that an enterprise may wish to restrict access to and/or monitor associated user activity). At block 510, one or more components of the system may respond to the subscription query 128 by transmitting at least a portion of the log 110 to an event forwarding service 118 that provides access to the at least a portion of the log outside of the isolated computing environment. In some implementations, the event forwarding service 118 resides and operates on the host OS 1022 route the log data 110 through the one or more servers 124. For example, the event forwarding service 118 may transmit the log 110 through the one or more servers 124 to a client device 122 that enables a policy manager 120 to perform analytics with respect to the log 110. In some implementations, the event forwarding service 118 resides and operates on a cloud monitoring service 402 that stores and provides access to the log 110. For example, a policy manager 120 may utilize a client device 122 to provide user credentials to the cloud monitoring service 402 and, ultimately, to obtain access to the log 110 without the log data 110 having been transmitted through either the communications channel 130 or the host OS 102.

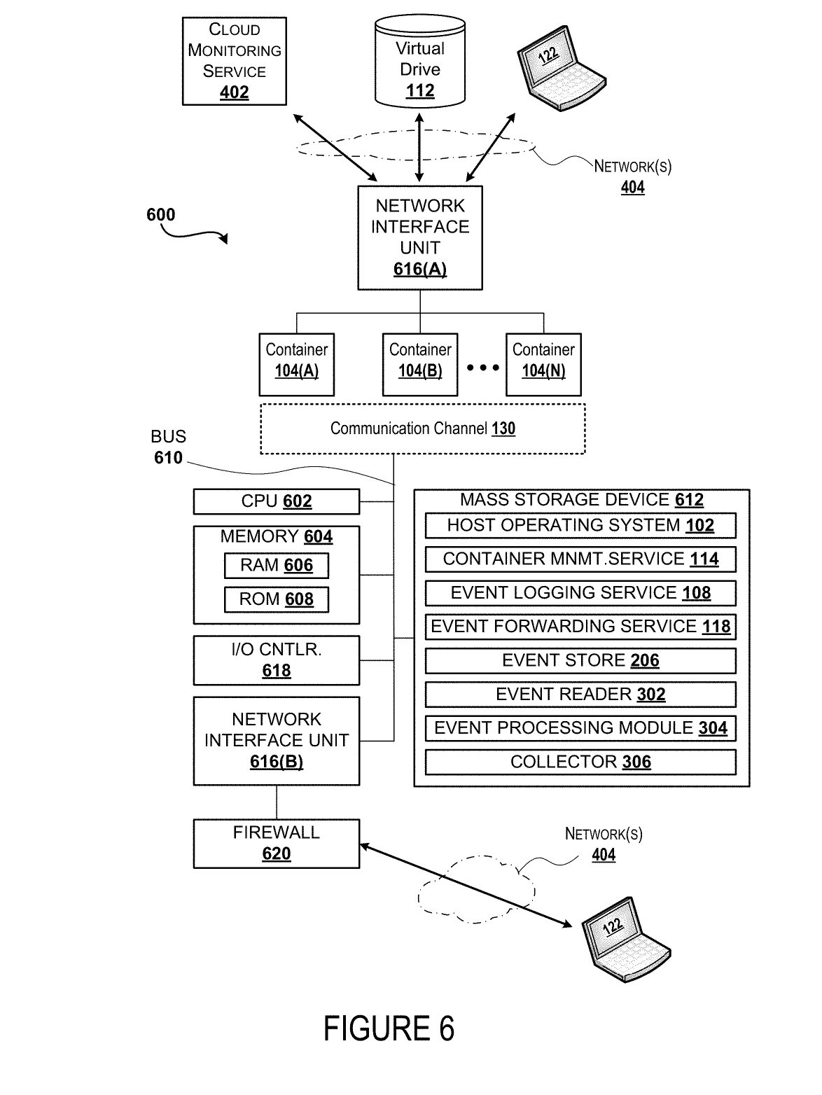

FIG. 6 shows additional details of an example computer architecture 600 for a computer capable of executing the systems and methods for auditing isolated computing environments described herein. In particular, the example computing architecture 600 is capable of executing functions described in relation to the host OS 102, the container 104, the container management service 114, the event logging service 108, the event forwarding service 118, the event store 206, the event reader 302, the event processing module 304, the collector 306, and/or any other program components thereof as described herein. Thus, the computer architecture 600 illustrated in FIG. 6 illustrates an architecture for a server computer, network of server computers, or any other types of computing devices suitable for implementing the functionality described herein. The computer architecture 600 may be utilized to execute any aspects of the software components presented herein.

The computer architecture 600 illustrated in FIG. 6 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing the host OS that supports the containers 104, other data, and one or more application programs. The mass storage device 612 may further include one or more of the container management service 114, the event logging service 108, the event forwarding service 118, the event store 206, the event reader 302, the event processing module, and/or the collector 306.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes of the claims, the phrase “computer storage medium,” “computer-readable storage medium” and variations thereof, does not include waves, signals, and/or other transitory and/or intangible communication media, per se.

According to various techniques, the computer architecture 600 may operate in a networked environment using logical connections to remote computers through a network 404 and/or another network (not shown). The computer architecture 600 may connect to the network 404 through one or more network interface units 616 connected to the bus 610 and/or one or more of the containers 104. In the illustrated embodiment, the plurality of containers 104 are connected to a first network interface unit 616(A) that provides the containers 104 with access to one or more cloud monitoring service 402, a virtual drive 112, and/or a client computing device 122. The computer architecture 600 further includes a communications channel 130 that isolates the individual containers 104 various components of the computer architecture 600 such as, for example, the host OS 102. The illustrated computer architecture 600 further includes a second network interface unit 616(B) that connects various components of the architecture that are not isolated from the containers 104 to the one or more networks 404 via a firewall 620 that is configured to provide the computer architecture 600 with inability to perform at least some outward communications while blocking unauthorized access from the networks 404. It should be appreciated that the network interface unit(s) 616 also may be utilized to connect to other types of networks and remote computer systems. The computer architecture 600 also may include an input/output controller 618 for receiving and processing input from a number of other devices, including a keyboard, mouse, or electronic stylus (not shown in FIG. 6). Similarly, the input/output controller 618 may provide output to a display screen, a printer, or other type of output device (also not shown in FIG. 6). It should also be appreciated that via a connection to the network 404 through a network interface unit 616, the computing architecture may enable communication between the functional components described herein.

It should be appreciated that the software components described herein may, when loaded into the CPU 602 and executed, transform the CPU 602 and the overall computer architecture 600 from a general-purpose computing system into a special-purpose computing system customized to facilitate the functionality presented herein. The CPU 602 may be constructed from any number of transistors or other discrete circuit elements, which may individually or collectively assume any number of states. More specifically, the CPU 602 may operate as a finite-state machine, in response to executable instructions contained within the software modules disclosed herein. These computer-executable instructions may transform the CPU 602 by specifying how the CPU 602 transitions between states, thereby transforming the transistors or other discrete hardware elements constituting the CPU 602.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 may include other types of computing devices, including hand-held computers, embedded computer systems, personal digital assistants, and other types of computing devices known to those skilled in the art. It is also contemplated that the computer architecture 600 may not include all of the components shown in FIG. 6, may include other components that are not explicitly shown in FIG. 6, or may utilize an architecture completely different than that shown in FIG. 6.

### Example Clauses

The disclosure presented herein may be considered in view of the following clauses.

Example Clause A, a computer-implemented method comprising: initiating an isolated computing environment to at least partially isolate a client application programming interface (API) from a host operating system (OS); receiving event data that indicates a plurality of computing events performed by the client API while operating within the isolated computing environment; generating, based on the event data, log data in accordance with one or more audit parameters to maintain a log of the plurality of computing events, wherein the log corresponds to a predetermined data type that the isolated computing environment is permitted to transmit to the host OS; receiving a request for at least a portion of the log of the plurality of computing events; and transmitting, in response to the request, the portion of the log to an event forwarding service that provides access to at least the portion of the log to at least one computing device that operates externally from the isolated computing environment.

Example Clause B, the computer-implemented method of Example Clause A, further comprising storing the log on a virtual drive that corresponds to the isolated computing environment, wherein the virtual drive is configured to persist subsequent to termination of the isolated computing environment.

Example Clause C, the computer-implemented method of any one of Example Clauses A through B, wherein the generating the log data includes transforming the event data into serialized event data that is configured according to a predetermined data format.

Example Clause D, the computer-implemented method of any one of Example Clauses A through C, wherein the transmitting the portion of the log to the event forwarding service includes transmitting the portion of the log over a network to a cloud monitoring service that operates independently from both of the host OS and the isolated computing environment, and wherein the portion of the log is transmitted to the cloud monitoring service without being transmitted through a communication channel to the host OS.

Example Clause E, the computer-implemented method of any one of Example Clauses A through D, wherein the transmitting the portion of the log to the event forwarding service includes transmitting the log over a communication channel to the host OS.

Example Clause F, the computer-implemented method of Example Clause E, wherein the communication channel is configured to restrict an ability of the isolated computing environment to transmit data to the host OS based on one or more predetermined datatypes.

Example Clause G, the computer-implemented method of any one of Example Clauses A through F, wherein the one or more audit parameters define first audit parameters corresponding to the host OS and second audit parameters corresponding to the isolated computing environment.

Example Clause H, the computer-implemented method of any one of Example Clauses A through G, wherein the request is a subscription query that at least partially associates a data subscription with the log.

Example Clause I, a system, comprising: at least one processor; and at least one memory in communication with the at least one processor, the at least one memory having computer-readable instructions stored thereupon that, when executed by the at least one processor, cause the at least one processor to: initiate a client application programming interface (API) within a container that is isolated from a host operating system (OS) by a communication channel; receive, from the client API, event data that indicates a plurality of computing events performed by the client API while operating within the container; generate a log of the plurality of computing events by transforming the event data in accordance with one or more audit parameters; receive a query that is indicative of at least a portion of the log of the plurality of computing events; and responsive to the query, transmit the portion of the log to an event forwarding service that operates externally from the container, wherein the event forwarding service provides access to the portion of the log through one or more servers.

Example Clause J, the system of Example Clause I, wherein the computer-readable instructions further cause the at least one processor to receive registration data that includes a container ID that uniquely identifies the container, wherein the registration data further includes the one or more audit parameters to define one or more types of computing events to record within the log.

Example Clause K, the system of any one of Example Clauses I through J, wherein the computer-readable instructions further cause the at least one processor to: cause the container to store at least the portion of the log to a virtual drive that is configured to persist subsequent to termination of the container; and cause the host OS to access the virtual drive to retrieve the portion of the log.

Example Clause L, the system of any one of Example Clauses I through K, wherein the one or more audit parameters indicate at least one of: types of computing events to maintain records for within the log, or types of client APIs to maintain records for within the log.

Example Clause M, the system of any one of Example Clauses I through L, wherein the transmitting the portion of the log to the event forwarding service includes transmitting the portion of the log over a network to a cloud monitoring service that operates independently from both of the host OS and the container.

Example Clause N, the system of any one of Example Clauses I through M, wherein generating the log includes transforming at least some of the event data into a predetermined data type that the communication channel permits the container to transmit to the host OS, and wherein the event forwarding service is configured to operate on the host OS.

Example Clause O, the system of any one of Example Clauses I through N, wherein the communication channel prevents the container from transmitting one or more predetermined datatypes to the host OS.

Example Clause P, the system of any one of Example Clauses I through O, wherein the computer-readable instructions further cause the at least one processor to store the log in at least one storage that is configured to persist subsequent to termination of the container.

Example Clause Q, a computer-implemented method comprising: initiating a plurality of containers to at least partially isolate a plurality of client application programming interfaces (APIs) from a host operating system (OS); receiving, from the plurality of containers, a plurality of instances of log data, wherein individual instances of the log data are generated by individual containers of the plurality of containers; receiving audit parameters that indicate one or more types of information to process for generating a consolidated log; and consolidate, based on the audit parameters, individual computing events from the plurality of instances of the log data to generate the consolidated log, wherein the consolidated log includes consolidated records of computing events performed by the plurality of client APIs within the plurality of containers.

Example Clause R, the computer-implemented method of Example Clause Q, further comprising: providing bias information to the individual containers to cause the individual containers to synchronize a plurality of timers across the plurality of containers, and deploy the plurality of timers to generate individual timestamps in association with individual computing events.

Example Clause S, the computer-implemented method of Example Clause R, wherein the individual containers include individual timers, and wherein the bias information enables the individual containers to synchronize the individual timers with the host OS.

Example Clause T, the computer-implemented method of Example Clause R, wherein the bias information is transmitted to the individual containers from a communication channel that isolates the plurality of client APIs from the host OS.

Conclusion

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computer-implemented method comprising:
initiating an isolated computing environment to at least partially isolate a client application programming interface (API) from a host operating system (OS);
receiving event data that indicates a plurality of computing events performed by the client API while operating within the isolated computing environment;
generating, based on the event data, log data in accordance with one or more audit parameters to maintain a log of the plurality of computing events, wherein the log corresponds to a predetermined data type that the isolated computing environment is permitted to transmit to the host OS;
receiving a request for at least a portion of the log of the plurality of computing events; and
transmitting, in response to the request, the portion of the log to an event forwarding service that provides access to at least the portion of the log to at least one computing device that operates externally from the isolated computing environment.

2. The computer-implemented method of claim 1, further comprising storing the log on a virtual drive that corresponds to the isolated computing environment, wherein the virtual drive is configured to persist subsequent to termination of the isolated computing environment.

3. The computer-implemented method of claim 1, wherein the generating the log data includes transforming the event data into serialized event data that is configured according to a predetermined data format.

4. The computer-implemented method of claim 1, wherein the transmitting the portion of the log to the event forwarding service includes transmitting the portion of the log over a network to a cloud monitoring service that operates independently from both of the host OS and the isolated computing environment, and wherein the portion of the log is transmitted to the cloud monitoring service without being transmitted through a communication channel to the host OS.

5. The computer-implemented method of claim 1, wherein the transmitting the portion of the log to the event forwarding service includes transmitting the log over a communication channel to the host OS.

6. The computer-implemented method of claim 5, wherein the communication channel is configured to restrict an ability of the isolated computing environment to transmit data to the host OS based on one or more predetermined datatypes.

7. The computer-implemented method of claim 1, wherein the one or more audit parameters define first audit parameters corresponding to the host OS and second audit parameters corresponding to the isolated computing environment.

8. The computer-implemented method of claim 1, wherein the request is a subscription query that at least partially associates a data subscription with the log.

9. A system, comprising:
at least one processor; and
at least one memory in communication with the at least one processor, the at least one memory having computer-readable instructions stored thereupon that, when executed by the at least one processor, cause the at least one processor to:
initiate a client application programming interface (API) within a container that is isolated from a host operating system (OS) by a communication channel;
receive, from the client API, event data that indicates a plurality of computing events performed by the client API while operating within the container;
generate a log of the plurality of computing events by transforming the event data in accordance with one or more audit parameters;
receive a query that is indicative of at least a portion of the log of the plurality of computing events; and
responsive to the query, transmit the portion of the log to an event forwarding service that operates externally from the container, wherein the event forwarding service provides access to the portion of the log through one or more servers.

10. The system of claim 9, wherein the computer-readable instructions further cause the at least one processor to receive registration data that includes a container ID that uniquely identifies the container, wherein the registration data further includes the one or more audit parameters to define one or more types of computing events to record within the log.

11. The system of claim 9, wherein the computer-readable instructions further cause the at least one processor to:
cause the container to store at least the portion of the log to a virtual drive that is configured to persist subsequent to termination of the container; and
cause the host OS to access the virtual drive to retrieve the portion of the log.

12. The system of claim 9, wherein the one or more audit parameters indicate at least one of: types of computing events to maintain records for within the log, or types of client APIs to maintain records for within the log.

13. The system of claim 9, wherein the transmitting the portion of the log to the event forwarding service includes transmitting the portion of the log over a network to a cloud monitoring service that operates independently from both of the host OS and the container.

14. The system of claim 9, wherein generating the log includes transforming at least some of the event data into a predetermined data type that the communication channel permits the container to transmit to the host OS, and wherein the event forwarding service is configured to operate on the host OS.

15. The system of claim 9, wherein the communication channel prevents the container from transmitting one or more predetermined datatypes to the host OS.

16. The system of claim 9, wherein the computer-readable instructions further cause the at least one processor to store the log in at least one storage that is configured to persist subsequent to termination of the container.

17. A computer-implemented method comprising:
initiating a plurality of containers to at least partially isolate a plurality of client application programming interfaces (APIs) from a host operating system (OS);
receiving, from the plurality of containers, a plurality of instances of log data, wherein individual instances of the log data are generated by individual containers of the plurality of containers;
receiving audit parameters that indicate one or more types of information to process for generating a consolidated log; and
consolidate, based on the audit parameters, individual computing events from the plurality of instances of the log data to generate the consolidated log, wherein the consolidated log includes consolidated records of computing events performed by the plurality of client APIs within the plurality of containers.

18. The computer-implemented method of claim 17, further comprising:
providing bias information to the individual containers to cause the individual containers to synchronize a plurality of timers across the plurality of containers, and
deploy the plurality of timers to generate individual timestamps in association with individual computing events.

19. The computer-implemented method of claim 18, wherein the individual containers include individual timers, and wherein the bias information enables the individual containers to synchronize the individual timers with the host OS.

20. The computer-implemented method of claim 18, wherein the bias information is transmitted to the individual containers from a communication channel that isolates the plurality of client APIs from the host OS.
